(19) United States
(12) Patent Application Publication
(10) Pub. No.: US 2003/0121396 A1
(43) Pub. Date: Jul. 3, 2003

(54) Cylinder water key

(76) Inventor: Wm. Newell Sheridan, Birmingham, AL (US)

Correspondence Address: Wm. Newell Sheridan, 945 Mountain Branch Drive, Birmingham, AL, 35226, US

(21) Appl. No.: 10/039,532

(22) Filed: Dec. 31, 2001

(51) Int. Cl. G10D 7/10

(52) U.S. Cl. 84/397

(57) ABSTRACT

A cylindrical water key comprises a spring loaded valve assembly which may be pressed onto a hole at a low point in a lung powered musical instrument. The portion which attaches to the instrument may be made to be flush with the interior wall of the instrument when in the unactivated state. The movable portion need only be two pieces rigidly attached together so that when the outer end is pressed, the inner end rises slightly into the interior of the instrument allowing for the undesired accumulated fluid to flow out of the instrument for discard. For trombones it results in a water key that may be operated hands free.

### BACKGROUND OF THE INVENTION

I. Field of the Invention

This Invention relates generally to a method and apparatus for removing undesired water-based fluid accumulation from lung powered musical instruments and more particularly to a new water key for trombones and other musical instruments.

II. Prior Art and Other Considerations

It is known that in the operation of a lung powered musical instrument that the vehicle for delivering the power to the instrument is the breath of the musician. The disadvantage of this is that such breath is heavily ladened with vaporized water-based moisture and water-based moisture particles. This develops into a disadvantage when this moisture condenses inside the instrument, into a fluid. As this process continues the moisture accumulates at a low point in the instrument and eventually constricts the airflow sufficiently to degrade the quality of the output of the instrument.

It is expedient, therefore, to provide on a musical instruments, a low point orifice having a generally spring loaded, manually operated sealing cover so that when operated the cover moves away from and opens the orifice thus allowing accumulated undesired water-based fluid to flow out of the musical instrument. This provides for the prevention of an excessive accumulation of such fluid which would degrade the quality of the instrument.

One typical prior art mode of such moisture removal is on the trombone. This mode typically has five (5) pieces, namely a slide tip, a water key bracket, a water key lever, a spring, and a water key nipple. This assembly and other prior art modes suffer from some or all of important disadvantages including being award, complicated, heavier than necessary and requiring significant maintenance, being vulnerable to damage, suffering deterioration with usage and providing no protection to the instrument.

Prior art modifications and variations have met with only limited success, however, in achieving the desired result efficiently, economically, and functionally.

### SUMMARY

In view of the foregoing, it is an object of the present Invention to provide a method and apparatus for effectively, efficiently, economically, and functionally removing undesired water-based fluid accumulation from lung powered musical instruments in a manner that minimizes additional turbulence inside the instrument which normally results from the introduction of a typical water key.

An advantage of the present Invention is the provision of a method and apparatus for effectively, efficiently, economically, and functionally removing undesired water-based fluid accumulation from lung powered musical instruments wherein the operation by the musician is comfortable and by the natural action of the musician.

An another advantage of the present Invention is the provision of a method and apparatus for effectively, efficiently, economically, and functionally removing undesired water-based fluid accumulation from lung powered musical instruments wherein the contour of the instrument is closely accommodated.

An still another advantage of the present Invention is the provision of a method and apparatus for effectively, efficiently, economically, and functionally removing undesired water-based fluid accumulation from lung powered musical instruments in such a manner so as to reduce the inconvenience of vulnerability to damage to the instrument resulting from inadvertent bumps and snags received by a conventional water key.

An yet another advantage of the present Invention is the provision of a method and apparatus for effectively, efficiently, economically, and functionally removing undesired water-based fluid accumulation from lung powered musical instruments wherein further protection from damage resulting from bumps is provided.

In accordance with features of this Invention, a water key comprises a tubular housing and a valve assembly, comprising a valve, an actuator and a spring, which housing is mounted to the instrument by press fit or any other suitable known means and which housing is mounted so that its axis is perpendicular to the inside wall of the air passageway of the instrument at the point of attachment, and which valve minimizes additional turbulence inside the instrument which normally results from the introduction of a typical water key.

### BRIEF DESCRIPTION OF THE DRAWINGS

FIG. 1 is a perspective side view of a first preferred embodiment of a water key, comprising a housing and a valve assembly showing the valve assembly in its activated state, wherein the valve assembly comprises a valve, an actuator and a spring.

FIG. 2 is a perspective side view of the first preferred embodiment of the water key of FIG. 1 in an unactivated state.

FIG. 3 is a perspective side view of the housing of the first preferred embodiment of the water key of FIG. 1.

FIG. 4 is a perspective side view of the valve of the first preferred embodiment of the water key of FIG. 1

FIG. 5 is a perspective side view of the actuator of the first preferred embodiment of the water key of FIG. 1

FIG. 6 is a perspective side view of the spring of the first preferred embodiment of the water key of FIG. 1

FIG. 7 is an exploded perspective side view of the first preferred embodiment of the water key of FIG. 1

An Index of Reference Characters as well as an Index of Part Names follow:

BRIEF DESCRIPTION OF THE DRAWINGS INDEX
REFERENCE CHARACTERS

| | |
|---|---|
| 100 | Trombone Slide U-shaped End |
| 110 | Hole in Trombone Slide U-shaped End |
| 200 | Water Key |
| 300 | Housing |
| 310 | Flange, Housing Slide Attachment |
| 320 | Seat, Valve, Housing |
| 330 | Chamber, Spring, Housing |
| 333 | Shelf, Spring, Chamber, Housing |
| 400 | Assembly, Valve |
| 440 | Valve |
| 443 | Airflow Surface, Valve |
| 446 | Seat Surface, Valve |
| 448 | Shaft, Partially Threaded, Valve |
| 450 | Actuator, Valve |
| 453 | Inner Surface, Actuator |
| 458 | Hole, Valve Actuator Shaft Threaded |
| 460 | Spring, Valve |

INDEX OF PART NAMES

| | |
|---|---|
| 450 | Actuator, Valve |
| 443 | Airflow Surface, Valve |
| 400 | Assembly, Valve |
| 330 | Chamber, Spring, Housing |
| 310 | Flange, Housing Slide Attachment |
| 110 | Hole in Trombone Slide U-shaped End |
| 458 | Hole, Valve Actuator Shaft Threaded |
| 300 | Housing |
| 453 | Inner Surface, Actuator |
| 446 | Seat Surface, Valve |
| 320 | Seat, Valve, Housing |
| 448 | Shaft, Partially Threaded, Valve |
| 333 | Shelf, Spring, Chamber, Housing |
| 460 | Spring, Valve |
| 100 | Trombone Slide U-shaped End |
| 440 | Valve |
| 200 | Water Key |

### DETAILED DESCRIPTION OF THE INVENTION

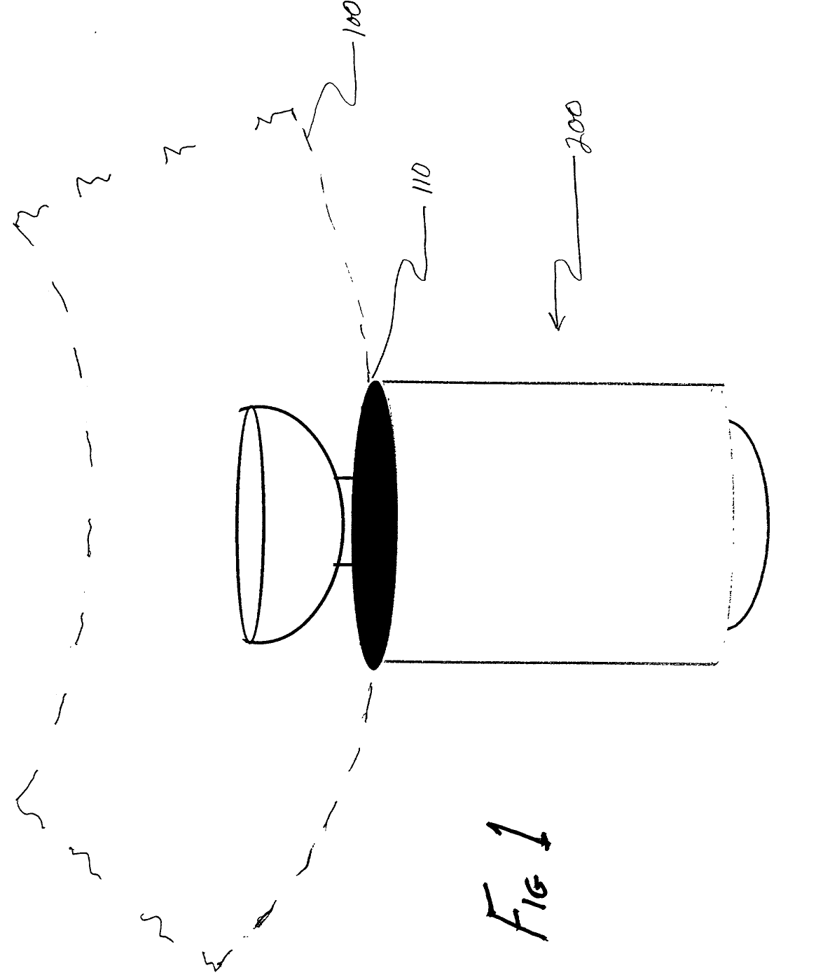

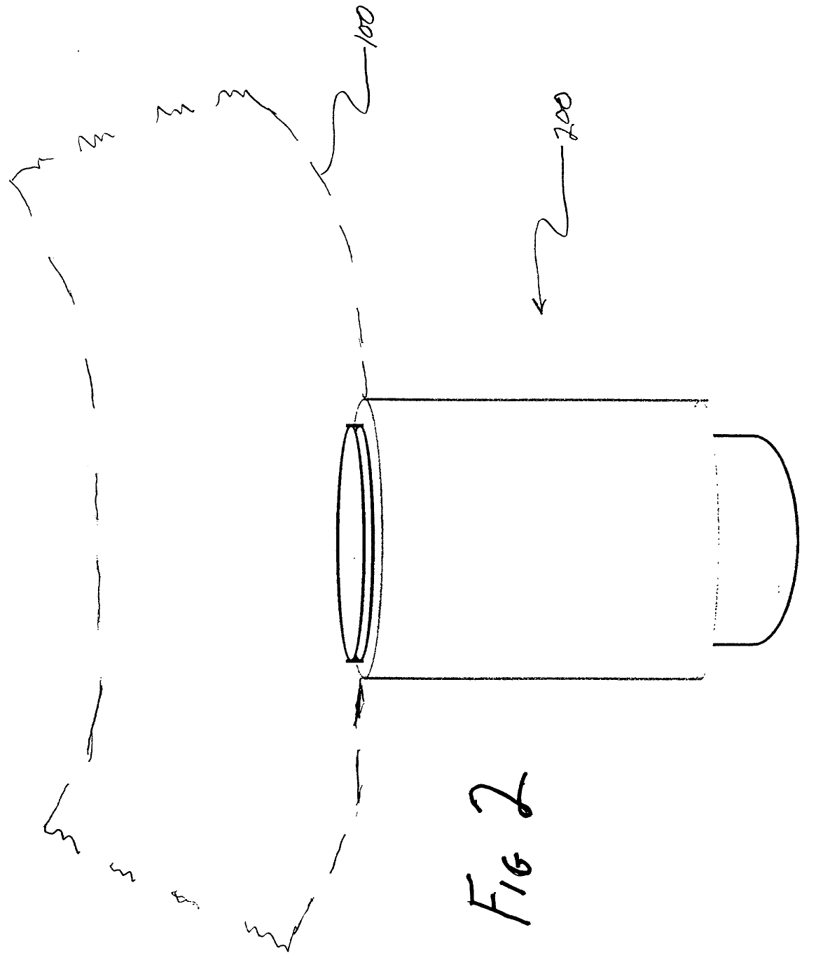

The water key of FIG. 1 comprises a housing 300 of FIG. 3 and a valve assembly 400.

The housing 300 has a flange 310, a valve seat 320, and a spring chamber 330. The flange 310 is fabricated for a rigid press fit in a hole 110 in the U-shaped portion of a trombone slide 100. The seat 320 is fabricated to block airflow from the U-shaped portion of the trombone slide 100 when in its unactivated state. The chamber 330 has a spring shelf 333 at the inside end.

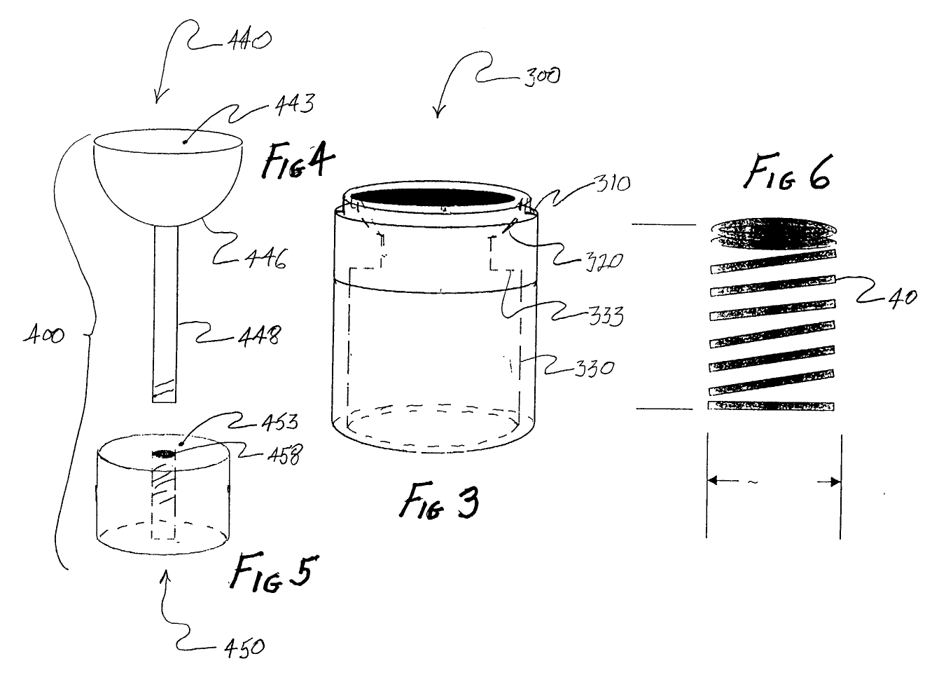

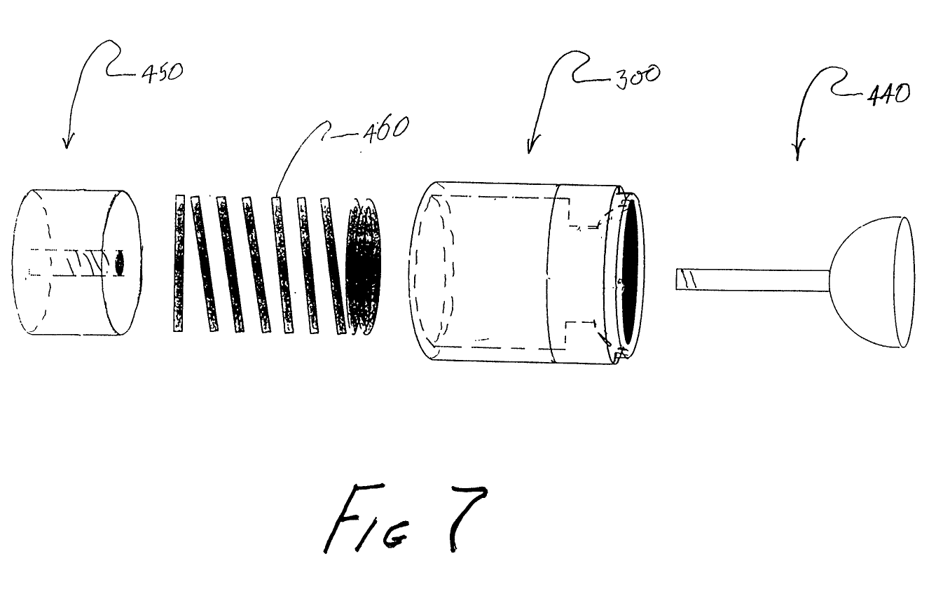

The valve assembly 400 comprises a valve 440 of FIG. 4, an actuator 450 of FIG. 5, and a spring 460 of FIG. 6.

The valve 440 has an airflow surface 443, a valve seat surface 446 and a shaft 448. The airflow surface 443 is shaped to minimize air turbulence inside the instrument when in an unactivated state. The valve seat surface 446 is fabricated so that there is no airflow through the chamber 330 when in the unactivated state. The shaft 448 is at least partially threaded and has a length so that the valve 440 about the length of the housing 200.

The actuator 450 has a hole 458 that is threaded to mate the threads of the shaft 448 and has a diameter just smaller than the chamber 330. The length of the actuator 450 allows for accommodation of the spring 460 and the actuator 450 inside the chamber 330 so that the actuator 450 extends just outside of the chamber 330.

The spring 460 is no larger in diameter than the actuator 450 and larger enough to fit securely on the shelf 333.

The water key 200 is assembled by placing the shaft 448 past the valve seat 446 and into the chamber 330 and held there. Then the spring 460 was placed into the chamber 330 and held there. Then the actuator hole 458 is placed onto the shaft 448 by screwing the two together. Then the housing seat 320 is pressed in the mating slide hole 110 in the U-shaped portion of the trombone slide 100.

In operation, in the unactivated state, the spring 460 is compressed and pushes against the inner surface 453 of the actuator 450 as well as against the shelf 333. The pushes the actuator 450 away from the trombone slide 100 which pulls the valve seat surface 446 snugly against the seat 320 blocking airflow from the trombone over the seat 320.

To activate, the musician causes pressure against the actuator 450 which causes the valve to rise into the slide 100 allowing airflow as well as any fluid present to traverse the seat 320 and flow through the chamber 330 and escape the trombone through the water key.

The embodiments of the Invention in which an exclusive property or privilege is claimed are defined as follows:

1. An apparatus for for removing undesired water-based fluid accumulation from lung powered musical instruments such as a trombone, said apparatus, which will fit into a hole in the instrument such as in the vicinity of the trombone slide tip, comprising:
a housing comprising
a flange, fabricated for a rigid press fit in the hole in the trombone slide,
a valve seat, fabricated to block airflow from the trombone slide when in its unactivated state, and
a spring chamber, having a spring shelf at the inside end, and
a valve assembly comprising
a valve, having
an airflow surface, shaped to minimized air turbulence inside the instrument when in an unactivated state
a valve seat surface, fabricated so that there is no airflow through the chamber when in the unactivated state, and
a shaft,
at least partially threaded and
having a length so that the valve is about the length of the housing,
an actuator,
having a hole that is threaded to mate the threads of the shaft and
having a diameter just smaller than the chamber, and
having a length that allows for accommodation of the spring and the actuator inside the chamber so that the actuator extends just outside of the chamber, and
a spring, which is
no larger in diameter than the actuator and
large enough to fit securely on the shelf,
where in the shaft may be placed past the valve seat and into the chamber and the spring may be simultaneously placed into the chamber and
subsequently the actuator hole is screwably placed onto the shaft and
subsequently the housing seat is pressed into the mating slide hole in the vicinity of the trombone slide tip.

2. An apparatus for for removing undesired water-based fluid accumulation from lung powered musical instruments such as a trombone, said apparatus, which will fit into a hole in the trombone slide, comprising:
a means for allowing for removal of undesired water-based fluid accumulation when activated,
which means introduces no turbulence into the instrument and
which means may be operated hands free by a trombone player.
